(19) United States
(12) Patent Application Publication
(10) Pub. No.: US 2016/0159183 A1
(43) Pub. Date: Jun. 9, 2016

(54) NOISE REDUCTION FOR REAR SUSPENSION LEAF SPRING WITH TIP INSERT - ROUND HEAD

(71) Applicant: GM Global Technology Operations LLC, Detroit, MI (US)

(72) Inventor: OLEG G. BASIN, FRANKLIN, MI (US)

(21) Appl. No.: 14/561,888

(22) Filed: Dec. 5, 2014

(51) Int. Cl. B60G 13/04; B60G 11/02

(52) U.S. Cl. CPC B60G 13/04; B60G 11/02

(57) ABSTRACT

A product is disclosed for reducing noise in a leaf spring. The product may include a spring leaf and an insert including a body that has a first surface and an opposite second surface. A post may extend from the second surface of the head and into an opening in the spring leaf. The first surface may have a first edge and a second edge with a circular arc formed by the first surface from the first edge to the second edge to contact an adjacent leaf.

### TECHNICAL FIELD

The field to which the disclosure generally relates includes leaf springs and more particularly, to noise reduction in leaf springs.

### BACKGROUND

An automobile typically includes isolation elements to allow the wheel assemblies to move relative to the body thereby reducing the effect of road irregularities on the vehicle and its occupants. These isolation elements may take the form of springs that allow a wheel assembly, also called the unsprung mass, to move relative to the body or sprung mass. This movement may create undesirable noise as suspension components move relative to each other.

### SUMMARY OF ILLUSTRATIVE VARIATIONS

A number of variations may include a product for reducing noise in a leaf spring. The product may include a spring leaf extending from a first end to a second end and defining at least one opening proximal one of the first end and the second end. An insert may be disposed in the at least one opening. The insert may have a body including a head with a first surface and an opposite second surface. The insert may include a post extending from the second surface at least partially into the at least one opening. The first surface may have a first edge and a second edge with a circular arc formed by the first surface from the first edge to the second edge.

According to a number of other variations a spring assembly may include a plurality of leaves. The spring assembly may include a first leaf and a second leaf positioned adjacent the first leaf. The second leaf may extend from a first end to a second end and may define an opening adjacent either of the first end and the second end. An insert may be positioned in the opening. The insert may include a head having a first surface and an opposite second surface. A post may extend from the second surface of the head at least partially into the opening. The post may include a number of flexible sections each having a terminal end with a flange adjacent the terminal end to hold the insert in the opening. The first surface may extend from a first edge of the first surface to a second edge of the first surface. A circular arc may be formed by the first surface from the first edge to the second edge. The insert may be oriented in the opening such that the first surface faces the first leaf.

In a number of other variations, a spring assembly may include a first leaf having a first connection eye and a second connection eye. The first and the second connection eyes may be connected to the vehicle such that the first leaf flexes. A second leaf may have a center connected to the first leaf with first and second ends configured to separate from, and to contact, the first leaf when the first leaf flexes. A first insert and a second insert may be mounted near each end of the second leaf. Each of the first and the second inserts may have a head with a first surface and an opposite second surface. The first surface may have a first edge and a second edge, with a circular arc formed by the first surface from the first edge to the second edge. The circular arc may contact the first leaf when the first leaf flexes.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is an illustration of part of a vehicle's suspension system according to a number of variations.

FIG. 2 is an illustration of part of a leaf spring assembly according to a number of variations.

FIG. 3 is an isometric illustration of a leaf spring tip insert according to a number of variations.

FIG. 4 is a cross sectional illustration of the leaf spring tip insert of FIG. 3, taken along the line 4-4 shown in FIG. 3, according to a number of variations.

### DETAILED DESCRIPTION OF ILLUSTRATIVE VARIATIONS

The following description of the variations is merely illustrative in nature and is in no way intended to limit the scope of the invention, its application, or uses.

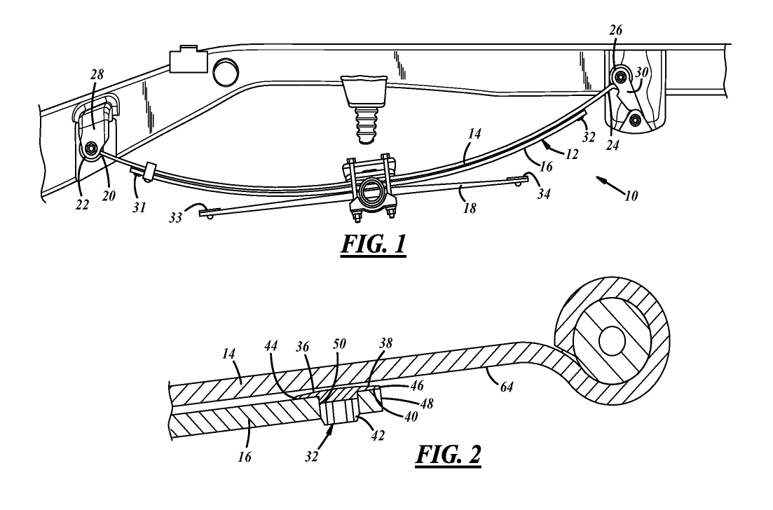

Referring to FIG. 1 part of the suspension system 10 of a vehicle is illustrated. A frame element may have a connected leaf spring assembly 12 with a first leaf 14, a second leaf 16 and a third leaf 18. In other applications a different number of leaves may be included. The first leaf may have a forward end 20 with a connection eye 22 and a rearward end 24 with a connection eye 26. The connection eye 22 may be connected to the frame element by a bracket 28 and the rear connection eye 26 may be connected to the frame element 10 by a shackle 30 that pivots, allowing the spring assembly 12 to flex. The leaves extend longitudinally along the frame element from the bracket 28 to the shackle 30. The leaves may be connected to each other at or near their center by a bolt, clamp or other device. As a result, the centers of the leaves are held together and when the spring assembly 12 flexes, the individual leaves may separate, contact, and slide relative to each other, particularly near their ends.

Near the ends of the leaves 16 and 18 inserts 31-34 may be secured to the leaves. The inserts may be as shown in FIG. 2 with an enlarged head 36 having a first surface 38 in the shape of a circular arc with a center presenting a higher profile than the two edges 44, 46, whereby the center is closer to the leaf 14 in the position illustrated. When the leaves flex, a different point along the surface 38 may be closer to, or contact, the leaf 14. The head 36 may have a second surface 40 from which a post 42 extends. The post 42 may have a complementary oval shaped cross section to fit the oval shaped hole or opening 50 so that orientation of the insert 32 is ensured to be correct, with the first surface 38 arcing in the longitudinal direction of the leaves 14 and 16. The surface 38 of the head 36 arcs from edge 44 to edge 46, and edge 46 may be aligned with the end 48 of the leaf 16.

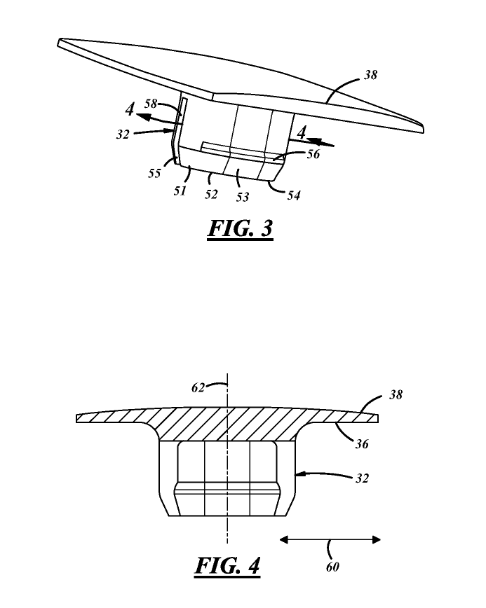

In FIG. 3 it can be seen that the post may include a number of flexible sections 51-55 each having a terminal end with a flange 56 near the terminal ends of at least some of the sections 51-55. When the post is inserted into the opening 50 (shown in FIG. 2), the sections 51-55 may flex inwardly, and once the flange 56 passes completely through the opening 50, they may flex outwardly to their normal position and the flange 56 may lock the insert 32 in the opening 50. The post 42 may have at least one gap 58 between the sections 51-55 to facilitate flexing.

Shown in cross section in FIG. 4, the insert 32 includes the enlarged head 36 with a circular arc shaped surface 38 arcing in the longitudinal direction 60. The arc of the surface 38 may be defined by a radius from a center point that is along the centerline 62 of the insert 32. With reference to FIG. 2, when the leaves 14 and 16 flex and the end 48 moves toward the leaf 14, the surface 38 may contact the surface 64 at a line along the circular arc and as the leaves continue to flex the surface 46 may roll along the surface 64 of leaf 14. As a result, a condition where the leaves 14 and 16 contact with a slapping sound or slide against one another is lessened, and the resulting noise may be avoided. In addition, the rolling action may result in less wear on the insert 32 as opposed to a sliding action.

The following description of variants is only illustrative of components, elements, acts, products and methods considered to be within the scope of the invention and is not in any way intended to limit such scope by what is specifically disclosed or not expressly set forth. Components, elements, acts, products and methods may be combined and rearranged other than as expressly described herein and still are considered to be within the scope of the invention.

Variation 1 may include a product for reducing noise in a leaf spring. The product may include a spring leaf extending from a first end to a second end and defining at least one opening proximal one of the first end and the second end. An insert may be disposed in the at least one opening. The insert may have a body including a head with a first surface and an opposite second surface. The insert may include a post extending from the second surface at least partially into the at least one opening. The first surface may have a first edge and a second edge with a circular arc formed by the first surface from the first edge to the second edge.

Variation 2 may include a product according to variation 1 wherein the head includes four sides that are each flat with the circular arc formed between an opposite two of the four sides.

Variation 3 may include a product according to variation 1 or 2 wherein the post has an oval shape.

Variation 4 may include a product according to any of variations 1 through 3 wherein the post includes a number of flexible sections each having a terminal end with a flange near the terminal end.

Variation 5 may include a spring assembly with a plurality of leaves. The spring assembly may include a first leaf and a second leaf positioned adjacent the first leaf. The second leaf may extend from a first end to a second end and may define an opening adjacent either of the first end and the second end. An insert may be positioned in the opening. The insert may include a head having a first surface and an opposite second surface. A post may extend from the second surface of the head at least partially into the opening. The post may include a number of flexible sections each having a terminal end with a flange adjacent the terminal end to hold the insert in the opening. The first surface may extend from a first edge of the first surface to a second edge of the first surface. A circular arc may be formed by the first surface from the first edge to the second edge. The insert may be oriented in the opening such that the first surface faces the first leaf.

Variation 6 may include a spring assembly according to variation 5 wherein the head includes four sides that are each flat with the circular arc formed between an opposite two of the four sides.

Variation 7 may include a spring assembly according to variation 5 or 6 wherein the opening has an oval shape and the post has an oval shape.

Variation 8 may include a spring assembly according to any of variations 5 through 7 wherein the insert is configured so that the circular arc contacts the first leaf and separates from the first leaf during deflection of spring assembly.

Variation 9 may include a spring assembly according to any of variations 5 through 8 wherein the circular arc is oriented relative to the second leaf in a longitudinal direction.

Variation 10 may include a spring assembly according to any of variations 5 through 9 wherein the circular arc rolls along the first leaf during deflection of the spring assembly.

Variation 11 may include a spring assembly with a first leaf having a first connection eye and a second connection eye. The first and the second connection eyes may be connected to the vehicle such that the first leaf flexes. A second leaf may have a center connected to the first leaf with first and second ends configured to separate from, and to contact, the first leaf when the first leaf flexes. A first insert and a second insert may be mounted near each end of the second leaf. Each of the first and the second inserts may have a head with a first surface and an opposite second surface. The first surface may have a first edge and a second edge, with a circular arc formed by the first surface from the first edge to the second edge. The circular arc may contact the first leaf when the first leaf flexes.

Variation 12 may include a spring assembly according to variation 11 wherein the head includes four sides that are each flat with the circular arc formed between an opposite two of the four sides.

Variation 13 may include a spring assembly according to variation 11 or 12 wherein each of the first and second inserts includes a post extending from its respective second surface of the head, where each post extends into one of a pair of openings in the second leaf.

Variation 14 may include a spring assembly according to variation 13 wherein the opening has an oval shape and the post has a corresponding oval shape to orient the insert in the opening.

Variation 15 may include a spring assembly according to any of variations 11 through 14 wherein the first leaf includes a longitudinal direction from one connection eye to the other, and the circular arc is oriented relative to the first leaf in the longitudinal direction.

Variation 16 may include a spring assembly according to any of variations 11 through 15 wherein the circular arc rolls along the first leaf when the first leaf flexes.

Variation 17 may include a spring assembly according to any of variations 11 through 16 wherein the circular arcs each terminate at an end of the second leaf.

The above description of select variations within the scope of the invention is merely illustrative in nature and, thus, variations or variants thereof are not to be regarded as a departure from the spirit and scope of the invention.

What is claimed is:

1. A product for reducing noise in a leaf spring comprising: a spring leaf extending in a longitudinal direction from a first end to a second end and defining at least one opening proximal one of the first end and the second end; and an insert disposed in the at least one opening; the insert having a body including a head with a first surface and an opposite second surface; the insert including a post extending from the second surface at least partially into the opening, the first surface having a first edge and a second edge with a circular arc formed by the first surface from the first edge to the second edge, wherein the circular arc is formed in the longitudinal direction only so that the first surface does not arc in a direction transverse to the longitudinal direction.

2. A product according to claim 1 wherein the head includes four sides that are each flat with the circular arc formed only between an opposite two of the four sides.

3. A product according to claim 1 wherein the post has an oval shape elongated in the longitudinal direction from a first side of the post to a second side of the post, the post including a gap at each of the first and second sides and has a pair of extending flanges to lock the insert in the opening, the pair of extending flanges located between the first and second sides and not at the first and second sides.

4. A product according to claim 1 further comprising a frame with the first and second ends of the spring leaf each connected with the frame.

5. A spring assembly of a vehicle comprising: a plurality of leaves including a first leaf extending in a first direction and a second leaf positioned adjacent the first leaf, wherein the second leaf extends in the first direction from a first end to a second end and defines an opening adjacent either of the first end and the second end; and an insert positioned in the opening; wherein the insert includes a head having a first surface and an opposite second surface, with a post extending from the second surface of the head at least partially into the opening, the post includes a number of flexible sections each having a terminal end with a flange adjacent the terminal end to hold the insert in the opening, the first surface extending from a first edge of the first surface to a second edge of the first surface, with a circular arc formed by the first surface from the first edge to the second edge, the first surface also extending from a third edge to a fourth edge, with a flat straight line formed along the first surface from the third edge to the fourth edge so that the first surface has the circular arc in only the first direction; wherein the insert is oriented in the opening such that the first surface faces the first leaf.

6. A spring assembly according to claim 5 wherein the head includes four sides, each one of which corresponds to one of the first, second, third or fourth edges, the four sides are each flat with the circular arc formed between an opposite two of the four sides and the flat straight line is formed between the other two of the four sides.

7. A spring assembly according to claim 5 wherein the opening has an oval shape and the post has a complementary oval shape elongated in the longitudinal direction from a first post side to a second post side, the post including a gap at each of the first and second post sides and has a pair of extending flanges to lock the insert in the opening, the pair of extending flanges located between the first and second post sides and not at the first and second post sides.

8. A spring assembly according to claim 5 wherein the insert is configured so that the circular arc contacts the first leaf at the flat straight line at a location along the circular arc, and separates from the first leaf during deflection of spring assembly.

9. A spring assembly according to claim 8 wherein the circular arc is oriented relative to the second leaf in the first direction.

10. A spring assembly according to claim 9 wherein the circular arc rolls along the first leaf during deflection of the spring assembly so that the flat straight line moves between the first edge and the second edge.

11. A spring assembly of a vehicle comprising: a first leaf extending between a first connection eye and a second connection eye, wherein the first and the second connection eyes are connected to the vehicle such that the first leaf flexes; a second leaf, wherein the second leaf has a center connected to the first leaf and has a first end and a second end, each of the first end and the second end configured to separate from, and to contact, the first leaf when the first leaf flexes; a first insert and a second insert, one of the first and the second inserts mounted near each end of the second leaf, wherein each of the first and the second inserts has a head with a first surface and an opposite second surface, where the first surface has a first edge and a second edge, with a circular arc formed by the first surface from the first edge to the second edge; wherein the circular arc contacts the first leaf when the first leaf flexes.

12. A spring assembly according to claim 11 wherein each head includes four sides that are each flat with the circular arc formed only between an opposite two of the four sides so that a straight line if formed by the first surface from a first of the other two sides to a second of the other two sides.

13. A spring assembly according to claim 12 wherein each of the first and second inserts includes a post extending from its respective second surface of the head, where each post extends into one of a pair of openings in the second leaf locking the inserts to the second leaf so that the second surface is held against the second leaf.

14. A spring assembly according to claim 11 wherein the second leaf has a first opening and a second opening, and wherein each opening has an oval shape and each post has a complementary oval shape that is received in one of the first and second openings to orient the inserts in the openings, each post elongated from a first post side to a second post side, each post including a gap at each of the first and second post sides and has a pair of extending flanges to lock the insert in the opening, the pair of extending flanges located between the first and second post sides and not at the first and second post sides.

15. A spring assembly according to claim 11 wherein the first leaf includes a longitudinal direction from one connection eye to the other connection eye, and the circular arcs are oriented relative to the first leaf in the longitudinal direction, and wherein a transverse direction is defined on each of the first surfaces perpendicular to the longitudinal direction, wherein at a point along either of the circular arcs on either of the first surfaces, each respective first surface defines a straight line in the transverse direction so that each straight line defines a contact between its respective insert and the first leaf, wherein the straight lines moves along the circular arcs when the first leaf flexes.

16. A spring assembly according to claim 11 wherein the circular arcs roll along the first leaf when the first leaf flexes.

17. A spring assembly according to claim 16 wherein each of the circular arcs terminates at one of the first end and the second end of the second leaf.

18. A product according to claim 1 wherein the head has a flat side at each of the first and second edges of the first surface, and wherein the spring leaf has an end, wherein the insert is locked in the opening by the post so that the flat side is aligned with the end of the spring leaf so that the flat side and the end together define a terminal surface that faces away from the center and the terminal surface is free of steps and gaps.

19. A product according to claim 18 wherein a transverse direction is defined on the first surface perpendicular to the longitudinal direction, wherein at a point along the circular arc on the first surface, the first surface defines a straight line in the transverse direction.

20. A product according to claim 19 comprising a second leaf, wherein the circular arc contacts and rolls along the second leaf when the spring leaf flexes, so that the straight line defines a contact between the insert and the second leaf, wherein the straight lines move along the circular arcs when the spring leaf flexes.
